(19) United States
(12) Patent Application Publication
(10) Pub. No.: US 2024/0407895 A1
(43) Pub. Date: Dec. 12, 2024

(54) MULTI-POSITION DOCKING OF HANDLE FOR ORAL IRRIGATORS

(71) Applicant: WATER PIK, INC., Fort Collins, CO (US)

(72) Inventors: Brian R. Williams, Fort Collins, CO (US); David R. Hull, Kirkland, WA (US)

(73) Assignee: WATER PIK, INC., Fort Collins, CO (US)

(21) Appl. No.: 18/738,583

(22) Filed: Jun. 10, 2024

Related U.S. Application Data
(60) Provisional application No. 63/472,441, filed on Jun. 12, 2023.

(51) Int. Cl. A61C 17/02

(52) U.S. Cl. CPC A61C 17/0202

(57) ABSTRACT

Multi-position docking of an oral irrigator handle is provided. An oral irrigator may include a handle and a base including a dock configured to secure the handle in multiple orientations or angular positions relative to the base, such as a first orientation associated with a use configuration, and a second orientation associated with a storage configuration. In the use configuration, a reservoir may be coupled to the base with the handle coupled to the dock in the first orientation. In the storage configuration, the base may be positioned at least partially within the reservoir with the handle coupled to the dock in the second orientation. The dock may include a docking surface that engages with the handle, and a retaining feature to secure the handle to the dock. For example, the handle may be magnetically coupled to the dock in each orientation, such as within different cradles of the dock.

### CROSS-REFERENCE TO RELATED APPLICATION

This application claims the benefit of U.S. Provisional Patent Application No. 63/472,441, titled “Multi-Position Docking of Handle for Oral Irrigators,” filed Jun. 12, 2023, which is incorporated by reference herein for all purposes.

### TECHNICAL FIELD

The present disclosure relates generally to oral health devices, such as oral irrigators.

### BACKGROUND

Many people use oral irrigators to maintain and improve oral health. Countertop oral irrigator units include a reservoir that connects to a base unit housing the pump and other internal components. These units are often too large to be easily portable. Further, many oral irrigator units may include a handle that is fluidly coupled to the reservoir, during use a user may manipulate the handle to irrigate different areas of his or her oral cavity. Typically, oral irrigator units include a static feature, such as a C-clamp to couple the handle to the base unit when not in use. However, this coupling can further extend the area of the unit, making it more difficult to transport or store, and leaving a user with a predetermined position for the handle, which may not be in an ideal position for a given user.

### SUMMARY

Various embodiments of the disclosure include an oral irrigator. The oral irrigator includes a handle and a base including a dock configured to secure the handle in a plurality of angular positions (e.g., in at least a first angular position and a second angular position) relative to the base. Optionally, the first and second angular positions are associated with different storage and/or use configurations of the oral irrigator. For example, the first angular position may be associated with a use configuration of the oral irrigator, and the second angular position (e.g., different from the first angular position) may be associated with a storage configuration of the oral irrigator. Optionally, the oral irrigator include a reservoir. In a use configuration of the oral irrigator, the reservoir may be coupled to the base with the handle coupled to the dock in the first angular position relative to the base. In a storage configuration of the oral irrigator, the base may be positioned at least partially within the reservoir with the handle coupled to the dock in the second angular position relative to the base. Optionally, the second angular position is 90 degrees offset from the first angular position. Optionally, the handle is magnetically coupled to the dock in the plurality of angular positions relative to the base. Optionally, the dock includes a locating feature to orient the handle relative to the base, and a retaining feature to secure the handle to the dock. Optionally, the dock (e.g., locating feature) includes a first cradle to receive the handle at the first angular position, and a second cradle to receive the handle at the second angular position. Optionally, the retaining feature includes at least one magnet (e.g., a first magnet of the dock and a second magnet of the handle) to magnetically couple the handle to the dock. Optionally, at least a portion of the dock is rotatable to secure the handle in the first and second angular positions relative to the base. Optionally, the dock includes a securing element to secure the handle in place, the securing element rotatable to secure the handle in the first and second angular positions relative to the base. Optionally, the oral irrigator includes a hose coupled to the handle, wherein the base includes a recess defined around a periphery of the dock to receive at least a portion of the hose stored around the dock.

Various embodiments of the disclosure include an oral irrigator. The oral irrigator includes a base including a dock, and a handle securable to the dock in at least first and second orientations relative to the base. The dock may include a docking surface that engages with the handle, and a retaining feature to secure the handle to the dock. Optionally, the oral irrigator includes a reservoir. In a use configuration of the oral irrigator, the reservoir may be coupled to the base with the handle coupled to the dock in a first angular position relative to the base. In a storage configuration of the oral irrigator, the base may be positioned at least partially within the reservoir with the handle coupled to the dock in one of the first orientation or the second orientation (e.g., in a second angular position relative to the base). Optionally, the one of the first orientation or the second orientation (e.g., the second angular position) allows the handle to be positioned at least partially within the reservoir in the storage configuration. Optionally, the first orientation includes a first angular position of the handle relative to the base, and the second orientation includes a second angular position of the handle relative to the base, the second angular position 90 degrees offset from the first angular position. Optionally, the oral irrigator includes a hose coupled to the handle. The base may include a recess defined around a periphery of the dock to receive at least a portion of the hose stored around the dock. Optionally, the retaining feature includes at least one magnet to magnetically couple the handle to the dock in the first orientation and the second orientation (e.g., the handle is magnetically coupled to the dock in the first and second orientations). Optionally, the dock (e.g., docking surface) defines a first cradle to receive the handle at the first orientation. Optionally, the dock (e.g., docking surface) defines a second cradle to receive the handle at the second orientation. Optionally, the dock includes a first magnet and the handle includes a second magnet to magnetically couple the handle to the dock. Optionally, at least a portion of the dock is rotatable to secure the handle in the first and second orientations. Optionally, the dock includes a securing element. The securing element may be rotatable to secure the handle in the plurality of angular positions relative to the base. The securing element may define both the docking surface and the retaining feature to secure the handle in place.

One of skill in the art will understand that each of the various aspects and features of the disclosure may advantageously be used separately in some instances, or in combination with other aspects and features of the disclosure in other instances. Accordingly, individual aspects can be claimed separately or in combination with other aspects and features. Thus, the present disclosure is merely exemplary in nature and is in no way intended to limit the claims or their applications or uses. It is to be understood that structural and/or logical changes may be made without departing from the spirit and scope of the present disclosure.

The present disclosure is set forth in various levels of detail and no limitation as to the scope of the claimed subject matter is intended by either the inclusion or non-inclusion of elements, components, or the like in this summary. In certain instances, details that are not necessary for an understanding of the disclosure or that render other details difficult to perceive may have been omitted. Moreover, for the purposes of clarity, detailed descriptions of certain features will not be discussed when they would be apparent to those with skill in the art so as not to obscure the description of the present disclosure. The claimed subject matter is not necessarily limited to the arrangements illustrated herein, with the scope of the present disclosure is defined only by the appended claims.

### BRIEF DESCRIPTION OF THE DRAWINGS

The description will be more fully understood with reference to the following figures in which components may not be drawn to scale, which are presented as various embodiments of the oral irrigator and/or vibration isolator described herein and should not be construed as a complete depiction of the scope of the claimed features.

FIG. 1 is an isometric view of an oral irrigator in a use configuration.

FIG. 2 is an isometric view of the oral irrigator of FIG. 1 in a storage configuration.

FIG. 3 is an isometric view of a base of the oral irrigator of FIG. 1.

FIG. 4 is a partial cross-section view of the connection between a handle and a dock of the oral irrigator of FIG. 1 and taken along line 4-4 of FIG. 1.

FIG. 5 is a partial cross-section view of the connection between a handle and a dock of the oral irrigator of FIG. 2 and taken along line 5-5 of FIG. 2.

FIG. 6 is an isometric view of another base of an oral irrigator.

FIG. 7 is an isometric view of another base of an oral irrigator.

Embodiments of this disclosure and their advantages are best understood by referring to the detailed description that follows. It should be appreciated that like reference numerals are used to identify like elements illustrated in one or more of the figures.

### DETAILED DESCRIPTION

Embodiments of the present disclosure relate to multi-position docking of oral irrigator handles or other oral health devices, such as brushes or other hand held instruments. In some examples, a docking assembly allows a handle to be positioned or coupled to a base or dock in a plurality of different positions and configurations, helping to allow a more compact transition (e.g., between a use and storage configuration) and/or to accommodate different user preferences. The discussion of any particular element, feature, component, assembly, or the like, should be understood as being a standalone element, or may be integrated into a system. Relatedly, although the discussion presented herein is related to oral irrigators, the concepts and embodiments may be applicable other types of oral health devices, such as, but not limited to, brushing devices, combination irrigating brushing devices, among other elements.

In one or more embodiments, a dock is provided to secure an oral irrigator handle in a plurality of angular positions relative to a base of an oral irrigator. For example, the dock may secure the oral irrigator handle in a first angular position and a second angular position different from the first angular position. In some embodiments, the first position is associated with a use configuration and the second angular position is associated with a storage configuration of the oral irrigator. The dock may allow quick and easy switching between the first and second angular positions. For instance, the dock may include first and second cradles or securing elements to capture or encourage the handle in the first and second angular positions, respectively. In embodiments, the dock (or portions thereof) may rotate to move the handle between angular positions. The dock may include surface features, e.g., recesses, on the outer surface that help to encourage the handle to seat in a particular position or may be configured to allow positioning in any number of positions.

In one or more embodiments, a dock is provided to secure an oral irrigator handle in both a use configuration and a storage configuration of an oral irrigator. In the use configuration, the dock secures the handle in a first orientation relative to a base of the oral irrigator for ease of grasping the oral irrigator for use. In the storage configuration, the dock secures the handle in a second orientation relative to the base to allow at least partial nesting of the various components for compact storage. For example, rotation of the handle to the second orientation may allow the handle and base to be positioned at least partially (e.g., slide) within a reservoir of the oral irrigator. In this manner, the reservoir may be sleeved over or otherwise positioned to at least partially enclose or cover the handle and/or base for compact storage. The handle may be magnetically coupled to the dock in at least one (e.g., both) of the use configuration and the storage configuration or may include mechanical elements to secure the handle to the dock in various positions (e.g., clamp or brackets can be used).

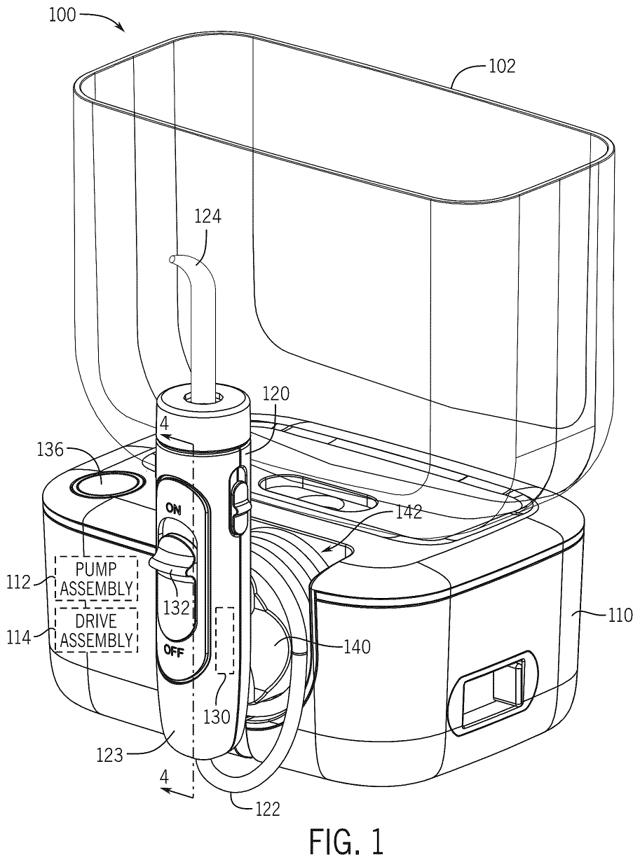

FIG. 1 is an isometric view of an oral irrigator 100. The oral irrigator 100 may include a reservoir 102 that holds a fluid, such as water or mouthwash, to provide the fluid to a pump. In instances where the oral irrigator 100 is a countertop unit, the reservoir 102 may be coupled to a housing or base 110. The size and/or volume capacity of the reservoir 102 may be based on the type and/or configuration of the oral irrigator 100. The reservoir 102 may include a reservoir outlet, such as a port or plug, valve, or the like, that is fluidly coupled to other components of the oral irrigator 100 (e.g., the base 110, a pump assembly, etc.).

The base 110, which may be referred to as a base unit or base portion, acts to support the oral irrigator 100 on a surface (e.g., a countertop) and optionally may support the reservoir 102. The base 110 supports and/or encloses one or more components of the oral irrigator 100, such as a pump assembly 112 and/or a drive assembly 114. Additionally, the base 110 may include fluid pathways (e.g., tubes, hoses) that direct fluid between different components of the oral irrigator, such as between the reservoir 102 and the pump assembly 112 and/or drive assembly 114 and an outlet, such as a handle 120.

The handle 120 may be fluidly coupled to the reservoir 102, such as via a hose 122 or other fluid connector. The handle 120 may include a housing 123 configured to be held by a user and/or a tip 124 or other outlet device that can direct fluid from the reservoir 102 into a user's oral cavity. The handle 120 may be configured to be held in a user's hand and, in some embodiments, may include features of the base 110. For example, the pump assembly 112 and/or drive assembly 114 (or portions thereof) may be coupled to or positioned within the handle 120. The handle 120 may also include features to secure the tip 124 thereto and optionally allow release of the tip 124 therefrom. The tip 124 may be in the form of a jet tip or other tip configuration, e.g., may include bristles (e.g., nozzle integrated with a brush head), tongue scraper, or the like.

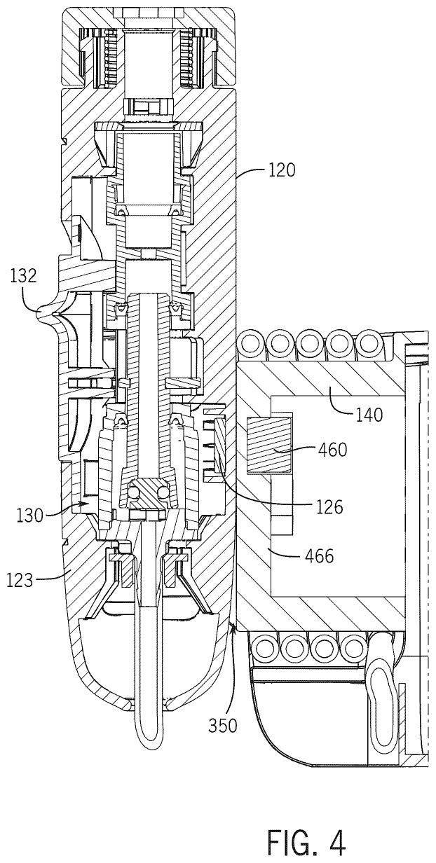

Referring to FIG. 4, for example, the handle 120 may include a magnet 126. As shown, the magnet 126 may be positioned within the housing 123 of the handle 120. For example, the magnet 126 may be coupled to an inner surface of the housing 123, such as via adhesive, friction fit, fasteners, mechanical elements, or other securement features. In embodiments, the magnet 126 may be formed with the housing 123 itself (e.g., molded into at least a portion of the housing 123, etc.). The magnet 126 may be positioned at the rear of the handle 120, such as on a side opposite of one or more handle controls (e.g., handle control 132), or in another position as may be desired for a coupling force location. As described more fully below, the magnet 126 may interact with a portion of the base 110 to function as a docking feature to secure the handle 120 in place. For example, the magnet 126 may interact with one or more magnets of the base 110 to magnetically dock the handle 120 to the base 110. In embodiments, the magnet 126 may be positioned to align the handle 120 via magnetic coupling with the base 110, such as in a certain orientation, as described below. As such, the magnet have a magnetic force that is sufficiently strong to support a weight of the handle to secure dock. In many embodiments, the magnet may be positioned within an interior cavity of the handle, e.g., to conceal the magnet, but in other embodiments may be positioned on an exterior of the handle, e.g., an outer surface.

Referring to FIG. 1, the handle 120 may include a handle valve 130 that allows selective closing of a fluid pathway from the hose 122 to the tip 124. The handle valve 130 may be coupled to a handle control 132, such as a button or switch that allows a user to stop flow through the tip 124. The handle valve 130 may be positioned within a flow pathway between the hose 122 and the tip 124, such as a handle flow path, and may seal, block, or otherwise prevent flow past the handle valve 130 when activated (e.g., by the handle control 132). In many embodiments, the handle valve 130 may be a mechanical valve and/or may not be in communication with the drive assembly 114 or pump assembly 112, such that when the handle valve 130 is activated (see FIG. 4), the pump assembly 112 may continue to pump fluid from the reservoir 102, but the fluid is blocked either within the handle 120 or another location along the flow pathway from exiting the tip 124.

The pump assembly 112 may include various pump components to pump and direct fluid from the reservoir 102 into the handle 120 and tip 124. For example, the pump assembly 112 may include a pump body, a piston, a connecting rod, and one or more valves. An example of the pump assembly 112 may be found in U.S. Pat. No. 8,888,727 titled “Vibration Damping for Dental Water Jet,” which is incorporated herein by reference for all purposes. The drive assembly 114 may be operably coupled to the pump assembly 112 and may include one or more drive elements (e.g., motor, linkages, gears, gear supports, etc.). For example, the drive assembly 114 may drive or actuate the pump assembly 112 or components thereof. An example of the drive assembly 114 may also be found in U.S. Pat. No. 8,888,727 identified above.

The oral irrigator 100 may include other features. For example, the oral irrigator 100 may include a power control 136, which may be in the form of a button, switch, or a knob. The power control 136 may turn the oral irrigator 100 on or off. Additionally, or alternatively, the power control 136 may switch the oral irrigator 100 between various operating modes. In some embodiments, the oral irrigator 100 may include a flow adjuster (e.g., as a part of a flow adjustment assembly) operable to reduce a flow volume delivered to the hose 122 and/or handle 120, which may reduce a pressure experienced by the user when operating the oral irrigator 100. For example, the user may turn the flow adjuster to increase or decrease the flow and correspondingly to increase or decrease the pressure.

FIG. 1 illustrates the oral irrigator 100 in a use configuration. As shown, the base 110 includes a dock 140 configured to secure the handle 120, such as when not in use, as described herein. The dock 140 may be defined by a cylindrical or substantially cylindrical portion extending from the base 110, such as from a front face of the base 110. For example, the dock 140 may define a mandrel extending outwardly from the base 110 to include a wrapping surface to receive the hose 122, although other configurations are contemplated. In such embodiments, the hose 122 may be stored (e.g., coiled) around the dock 140. In embodiments, a recess 142 may be defined around a periphery of the dock 140 to receive at least a portion of the hose 122 stored around the dock 140.

In the use configuration of the oral irrigator 100, the reservoir 102 may be coupled to the base 110, such as seated on top of the base 110. In addition, the handle 120 may be coupled to the dock 140, such as in a manner as described below. For example, the dock 140 may releasably hold the handle 120 in place while the handle 120 is not in use, such as via magnetism and/or one or more engagement structures, as detailed below. As shown in the use configuration of FIG. 1, the handle 120 may be secured to the dock 140 in a first orientation relative to the base 110. For instance, the handle 120 may extend in a first angular position (e.g., vertically or generally vertically) relative to the base 110, as shown without intent to limit. Such configurations may position the handle 120 for ease of grasping of the handle 120 for use.

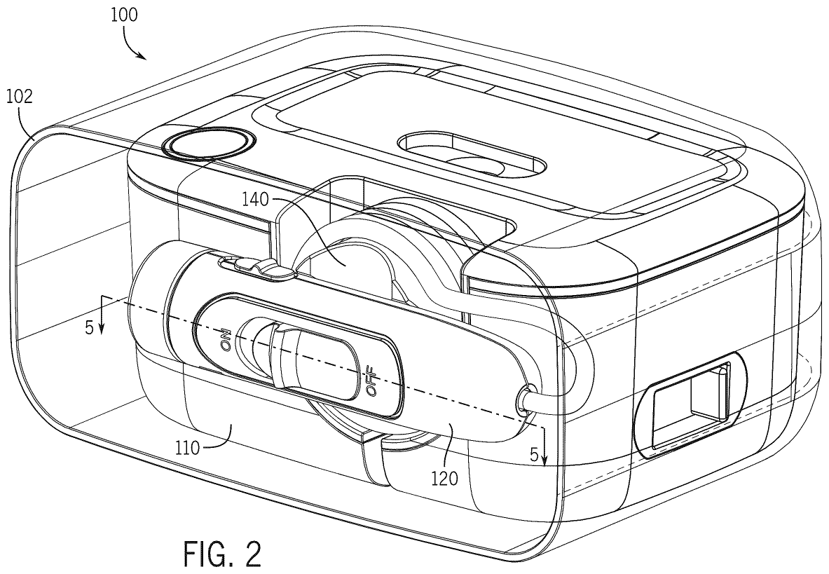

FIG. 2 is an isometric view of the oral irrigator 100 in a storage configuration. For example, the reservoir 102 is dimensioned and shaped not only to hold a desired amount of fluid, but also to correspond to the shape and dimensions of the base 110, such that the base 110 fits at least partially within the reservoir 102. Referring to FIG. 2, in the storage configuration of the oral irrigator 100, the base 110 is positioned at least partially within the reservoir 102 with the handle 120 coupled to the dock 140. For example, the handle 120 may be secured to the dock 140 in the same or a similar manner as described above with reference to the use configuration. In this manner, the dock 140 may be configured to secure the handle 120 in both the use configuration and the storage configuration. When docked, the handle 120 may be positioned at least partially within the reservoir 102 in the storage configuration of the oral irrigator 100. The configuration shown in FIG. 2 is one non-limiting example of the storage configuration of the oral irrigator 100, and the base 110 and handle 120 may be positioned within the reservoir 102 in other configurations. For instance, the reservoir 102 may be slid over the base 110 and handle 120 from the side or from the front, rather than from the back as shown. For example, the handle 120 may be positioned at the bottom of the reservoir 102, with the base 110 positioned above the handle 120 within the reservoir 102. As shown, the tip 124 may be removed from the handle 120, such as to allow positioning of the handle 120 at least partially within the reservoir 102, although other configurations are contemplated.

As shown in the storage configuration of FIG. 2, the handle 120 may be secured to the dock 140 in a second orientation relative to the base 110. For instance, the handle 120 may extend in a second angular position different than the first angular position relative to the base 110, as shown without intent to limit. For example, the second angular position may be horizontal or generally horizontal compared to a vertical or generally vertical first angular position. In embodiments, the second angular position may allow the handle 120 to be positioned at least partially within the reservoir 102 in the storage configuration, although other configurations are contemplated. Depending on the application, the second angular position may be offset from the first angular position by about 90 degrees+/−10 degrees without intent to limit.

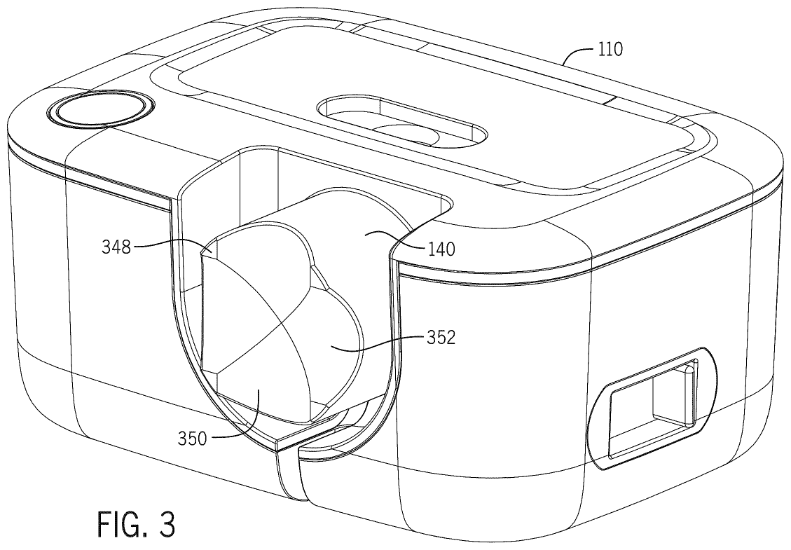

FIG. 3 is an isometric view of the base 110. The dock 140 may include various locating features allowing the handle 120 to be positioned between the first angular positon and the second angular position (or first and second positions). In embodiments, the dock 140 includes a docking surface 348 having or defining one or more seating features for the handle 120, such as recesses that form or define one or more cradles (e.g., a first cradle 350 and a second cradle 352) that seat the handle 120 (e.g., such that the docking surface 348 engages with the handle 120). Each of the first cradle 350 and the second cradle 352 may be a concave-shaped recessed feature (e.g., complementary to a convex shape of the handle 120) defined in the end of the dock 140 to receive at least a portion of the handle 120 at certain orientations or positions. For example, the first cradle 350 may be defined by a first (e.g., arcuate such as cylindrical) cutout or recess in the end of the dock 140, and the second cradle 352 may be defined by a second (e.g., arcuate such as cylindrical) cutout or recess in the end of the dock 140. Such embodiments are exemplary only, and the docking surface 348 may include other configurations. For instance, the docking surface 348 may be planar or generally curved to allow free positioning of the handle 120 to the dock 140. Embodiments including locating or seating features help to encourage the handle to seat in a particular configuration, e.g., the storage configuration, which may help ensure that the reservoir or other components will accurately seat at intended (e.g., the handle will not interfere with the position of the reservoir). Additionally, the seating features may help to encourage the handle to remain docked and prevent inadvertent removal of the handle from the dock.

It should be noted that in some embodiments, the dock may include recesses or other locating features that set predetermined locations for the different angular positions. However, in other embodiments, the dock may include a generally planar or slightly curved surface that may not include specific locators or other features, thus allowing a user more freedom in positioning the handle on the dock. In these embodiments, the magnetic attraction between the handle and the dock may be configured to fully support the handle relative to the dock.

As shown, the first cradle 350 may extend along a first direction (e.g., vertically or perpendicular to a longitudinal axis of the base) in the end of the dock 140 to receive the handle 120 at the first angular position (e.g., of the use configuration). Similarly, the second cradle 352 may extend along a second direction (e.g., horizontally or parallel to a longitudinal axis of the base) in the end of the dock 140 to receive the handle 120 at the second angular position (e.g., of the storage configuration). In this manner, the dock 140 may be configured to secure the handle 120 in a plurality of angular positions relative to the base 110. As shown, the first cradle 350 and the second cradle 352 may intersect along the face of the dock 140 to define an X-shaped cradle or other recess structure, although other configurations are contemplated.

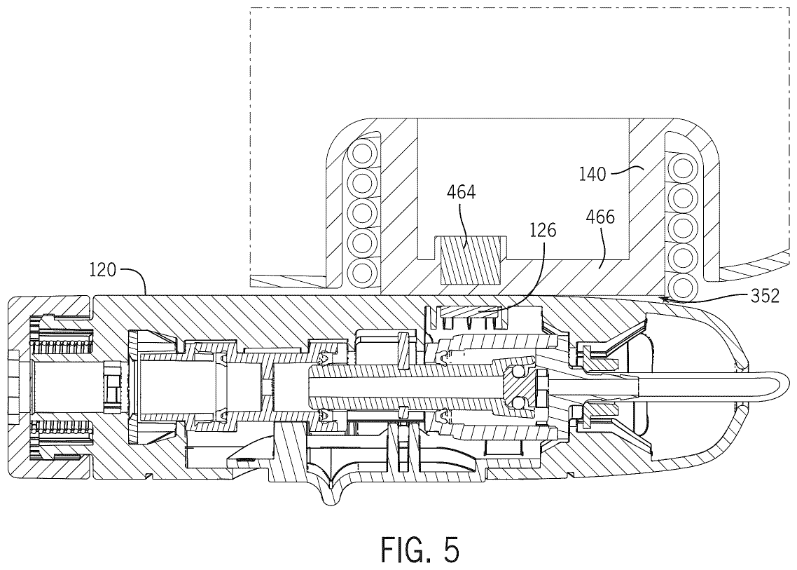

FIG. 4 is a partial cross-section view of the connection between the handle 120 and the dock 140 of the oral irrigator 100 and taken along line 4-4 of FIG. 1. FIG. 5 is a partial cross-section view of the connection between the handle 120 and the dock 140 of the oral irrigator 100 and taken along line 5-5 of FIG. 2. As shown in FIGS. 1-2, the handle 120 may be coupled to the dock 140 in a plurality of orientations or angular positions relative to the base 110 (e.g., in the first orientation or angular position and the second orientation or angular position). For example, the dock 140 may include one or more securing elements to secure the handle 120 in multiple orientations or angular positions, such as a retaining feature to secure the handle 120 to the dock 140. In examples, the securing element(s) may define both the docking surface 348 and the retaining feature to secure the handle 120 in place. Referring to FIG. 4, the retaining feature may include at least one magnet to magnetically couple the handle 120 to the dock 140. For example, the dock 140 may include a first magnet 460 as a securing element to magnetically couple the handle 120 to the dock 140 (e.g., for magnetic coupling with the magnet 126 of the handle 120). The first magnet 460 may be positioned at or near the end of the dock 140, such as at the center of the end of the dock 140 (e.g., at or near the intersection between the first cradle 350 and the second cradle 352, etc.). In embodiments, the first magnet 460 may be offset from the center of the end of the dock 140, as illustrated, such as to secure the handle 120 in the first cradle 350.

Referring to FIG. 5, the dock 140 may include a second magnet 464 as a securing element to couple the handle 120 to the dock 140. Similar to the first magnet 460, the second magnet 464 may be configured for magnetic coupling to the magnet 126 of the handle 120. As shown, the second magnet 464 may be positioned at or near the end of the dock 140, such as centered at or offset from the center of the end of the dock 140, to secure the handle 120 in the second cradle 352. Such embodiments are illustrative only, and the dock 140 may include a single magnet at the center of the end of the dock 140 to magnetically couple to the magnet 126 of the handle 120 to secure the handle 120 in either the first cradle 350 or the second cradle 352.

Referring to FIGS. 4-5, the dock 140 may include an end wall 466 to which the handle 120 is coupled. As shown, the first magnet 460 and/or the second magnet 464 may be coupled to the end wall 466, such as positioned or seated within the end wall 466. The first magnet 460 and/or the second magnet 464 may be secured to the end wall 466 via adhesive, friction fit, fasteners, mechanical elements, or other securement features. In embodiments, the first magnet 460 and/or the second magnet 464 may be formed with the dock 140 or end wall 466 itself (e.g., molded into at least a portion of the end wall 466, etc.). In embodiments, the end wall 466 may define the first magnet 460 and/or the second magnet 464 itself.

The magnets 126, 460, 464 may be positioned or otherwise configured to allow movement of the handle 120 between the first angular position and the second angular position. For example, the magnet configuration may facilitate quick and easy switching of the handle 120 between angular positions. Once positioned, the handle 120 may be held in the first angular position via the magnetic coupling between the magnet 126 of the handle 120 and the first magnet 460 of the dock 140, such as within the first cradle 350. Similarly, the handle 120 may be held in the second angular position via the magnetic coupling between the magnet 126 of the handle 120 and the second magnet 464 of the dock 140, such as within the second cradle 352.

Such implementations are illustrative only, and the dock 140 and/or handle 120 may include other configurations to magnetically couple the handle 120 to the dock 140. For example, one of the various magnets may be omitted. For instance, the first magnet 460 and/or the second magnet 464 may be omitted from the dock 140, in which case the dock 140 may include a magnetic material (e.g., in or defining the docking surface 348 or end wall 466) to magnetically couple the magnet 126 to the dock 140. Similarly, the magnet 126 may be omitted from the handle 120, in which case the handle 120 may include a magnetic material (e.g., in or defining the housing 123) to magnetically couple the first magnet 460 and/or the second magnet 464 to the handle 120. In embodiments, one or more magnets or magnetic material may extend along the first cradle 350 and/or the second cradle 352. In embodiments, one or more magnets or magnetic material may be positioned at certain locations within or adjacent to the first cradle 350 and/or the second cradle 352. For instance, one or more magnets or magnetic material may be positioned at the intersection of the first cradle 350 and the second cradle 352. Additionally, or alternatively, one or more magnets or magnetic material may be positioned at or near each end of the first cradle 350 and/or the second cradle 352 (e.g., at quarter regions of the dock 140 within each cradle).

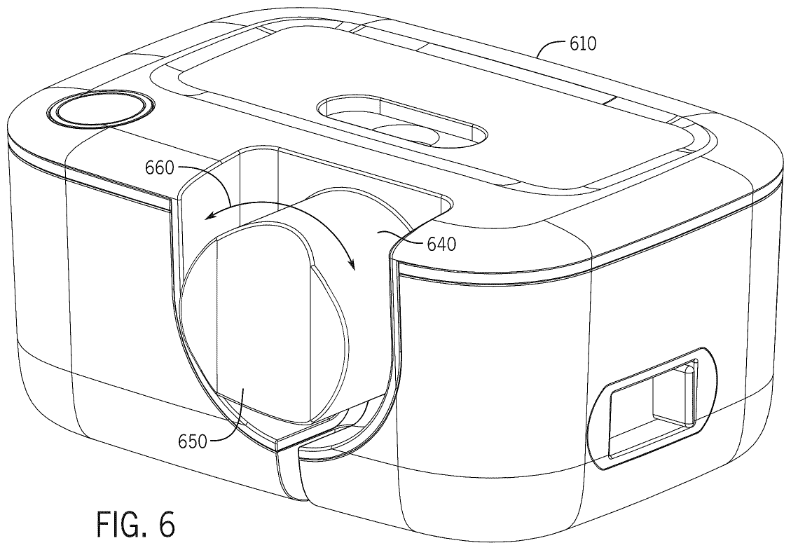

Although described as magnetically coupled to the dock 140 in predefined angular positions, the handle 120 may be secured in place in any angular position relative to the base 110 whether by a magnetic connection to the dock 140 or by different coupling features. For example, FIG. 6 is an isometric view of another base 610 of an oral irrigator (e.g., the oral irrigator 100). Except as otherwise described below, the base 610 may be similar to the base 110, described above. For example, the base 610 may include a dock 640 to secure the handle 120 thereto. As shown, the dock 640 may include a single cradle 650, similar to the first cradle 350 or second cradle 352 described above to receive and secure the handle 120 in place. At least a portion of the dock 640 may be rotatable to secure the handle 120 in a plurality of angular positions relative to the base 110. For instance, the dock 640 may rotate (e.g., in direction 660) to move the handle 120 between at least the first angular position and the second angular position. Alternatively, only an end portion of the dock 640 (e.g., a face plate of the dock 640) may rotate (e.g., in direction 660) to move the handle 120 between use and storage positions associated with the use and storage configurations of the oral irrigator 100.

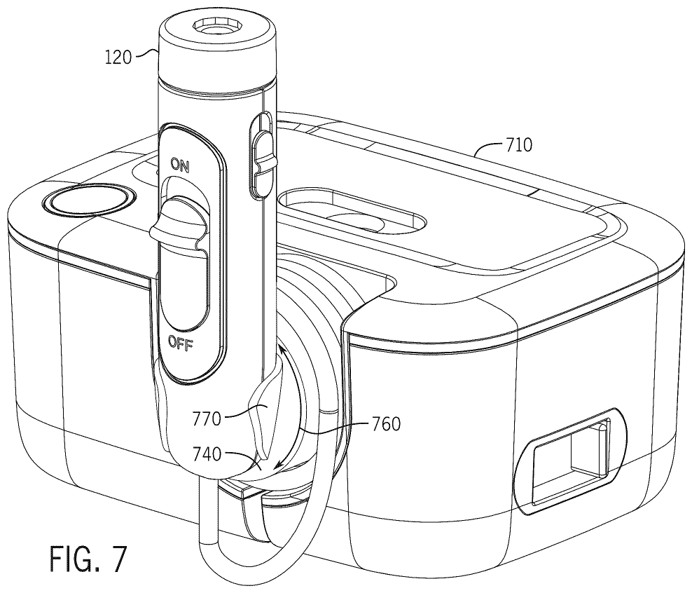

FIG. 7 is an isometric view of another base 710 of an oral irrigator (e.g., oral irrigator 100). Except as otherwise described below, the base 710 may be similar to the base 110 and/or the base 610, described above. For example, the base 710 may include a dock 740 to secure the handle 120 thereto. Referring to FIG. 7, the dock 740 may include a mechanical connection (e.g., a clamp or bracket 770) as a securing element to secure the handle 120 to the dock 740. The clamp or bracket 770 may include a C-clamp or other structure that clips to or holds a portion of the handle 120 to secure the handle 120 in place, such as the handle 120 seating within the clamp or bracket 770. The clamp or bracket 770 may be rotatable to secure the handle 120 in a plurality of angular positions. For example, the clamp or bracket 770 may rotate (e.g., in direction 760) via a rotatable portion of the dock 740 to move the handle 120 between use and storage positions associated with the use and storage configurations of the oral irrigator 100.

Any description of a particular component being part of a particular embodiment, is meant as illustrative only and should not be interpreted as being required to be used with a particular embodiment or requiring other elements as shown in the depicted embodiment.

All relative and directional references (including top, bottom, side, front, rear, and so forth) are given by way of example to aid the reader's understanding of the examples described herein. They should not be read to be requirements or limitations, particularly as to the position, orientation, or use unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and in fixed relation to each other, unless specifically set forth in the claims.

The present disclosure teaches by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. An oral irrigator comprising:
a handle; and
a base comprising a dock configured to secure the handle in at least a first angular position and a second angular position relative to the base.

2. The oral irrigator of claim 1, wherein the first and second angular positions are associated with different storage and/or use configurations of the oral irrigator.

3. The oral irrigator of claim 1, further comprising a reservoir, wherein:
in a use configuration of the oral irrigator, the reservoir is coupled to the base with the handle coupled to the dock in the first angular position relative to the base; and
in a storage configuration of the oral irrigator, the base is positioned at least partially within the reservoir with the handle coupled to the dock in the second angular position relative to the base.

4. The oral irrigator of claim 1, wherein the second angular position is 90 degrees offset from the first angular position.

5. The oral irrigator of claim 1, wherein the dock comprises a locating feature to orient the handle relative to the base, and a retaining feature to secure the handle to the dock.

6. The oral irrigator of claim 5, wherein the locating feature comprises:
a first cradle to receive the handle at the first angular position; and
a second cradle to receive the handle at the second angular position.

7. The oral irrigator of claim 5, wherein the retaining feature comprises at least one magnet to magnetically couple the handle to the dock.

8. The oral irrigator of claim 1, wherein at least a portion of the dock is rotatable to secure the handle in the first and second angular positions relative to the base.

9. The oral irrigator of claim 1, wherein the dock comprises a securing element to secure the handle in place, the securing element rotatable to secure the handle in the first and second angular positions relative to the base.

10. The oral irrigator of claim 1, further comprising a hose coupled to the handle, wherein the base comprises a recess defined around a periphery of the dock to receive at least a portion of the hose stored around the dock.

11. An oral irrigator comprising:
a base comprising a dock; and
a handle securable to the dock in at least first and second orientations relative to the base;
wherein the dock comprises:
a docking surface that engages with the handle, and
a retaining feature to secure the handle to the dock.

12. The oral irrigator of claim 11, further comprising a reservoir, wherein:
in a storage configuration of the oral irrigator, the base is positioned at least partially within the reservoir with the handle coupled to the dock in one of the first orientation or the second orientation.

13. The oral irrigator of claim 12, wherein the one of the first orientation or the second orientation allows the handle to be positioned at least partially within the reservoir in the storage configuration.

14. The oral irrigator of claim 11, wherein:
the first orientation comprises a first angular position of the handle relative to the base; and
the second orientation comprises a second angular position of the handle relative to the base, the second angular position 90 degrees offset from the first angular position.

15. The oral irrigator of claim 11, further comprising a hose coupled to the handle, wherein the base comprises a recess defined around a periphery of the dock to receive at least a portion of the hose stored around the dock.

16. The oral irrigator of claim 11, wherein the retaining feature comprises at least one magnet to magnetically couple the handle to the dock in the first orientation and the second orientation.

17. The oral irrigator of claim 16, wherein the docking surface defines:
a first cradle to receive the handle at the first orientation; and
a second cradle to receive the handle at the second orientation.

18. The oral irrigator of claim 16, wherein the dock comprises a first magnet and the handle comprises a second magnet to magnetically couple the handle to the dock.

19. The oral irrigator of claim 11, wherein at least a portion of the dock is rotatable to secure the handle in the first and second orientations.

20. The oral irrigator of claim 19, wherein the dock comprises a securing element defining both the docking surface and the retaining feature to secure the handle in place.
